(19) United States
(12) Patent Application Publication
(10) Pub. No.: US 2014/0000448 A1
(43) Pub. Date: Jan. 2, 2014

(54) HYDRAULIC-PNEUMATIC ACTUATOR

(71) Applicants: Samuel Jasper Franklin, III, Charlotte, NC (US); Volker Triebs, Wutoeschingen (DE); Stefan Gabriel, Schaffhausen (CH); Roland Zuelling, Hallau (CH); Michael Christof Kleiber, Dachsen (CH)

(72) Inventors: Samuel Jasper Franklin, III, Charlotte, NC (US); Volker Triebs, Wutoeschingen (DE); Stefan Gabriel, Schaffhausen (CH); Roland Zuelling, Hallau (CH); Michael Christof Kleiber, Dachsen (CH)

(73) Assignee: Curtiss-Wright Controls, Inc., Charlotte, NC (US)

(21) Appl. No.: 13/391,481

(22) PCT Filed: Feb. 20, 2012
(86) PCT No.: PCT/US12/25773

§ 371 Date: Jun. 7, 2012

Related U.S. Application Data
(60) Provisional application No. 61/444,359, filed on Feb. 18, 2011.

(51) Int. Cl. F15B 15/00

(52) U.S. Cl. CPC F15B 15/00
USPC 91/4 R

(57) ABSTRACT

An actuator for relatively moving two parts in a damped manner. The actuator includes a damper housing for connection to a first of the parts. The damper housing includes a damper chamber. The actuator includes a drivable damper rod for connection to a second of the parts and being movable relative to the damper housing. The damper rod includes a damper unit located within the damper chamber. The damper unit is relatively movable within the damper chamber with the damper unit movement corresponding to the relative movement between the damper housing and damper rod and the relative movement between the first and second parts. The damper unit is movable in response to hydraulic pressure force upon the damper unit. The actuator includes a pneumatic pressure source for providing a pneumatic pressure force that is transferred to provide the hydraulic pressure force upon the damper unit. The actuator includes a selectively actuatable blocking device for permitting transfer of the pneumatic pressure force from the pneumatic pressure source and blocking return of force to the pneumatic pressure source until the selectively actuatable blocking device is actuated.

### RELATED APPLICATION

Benefit is hereby claimed from U.S. Provisional Application Ser. No. 61/444,359, filed Feb. 18, 2011, the entire disclosure of which is hereby incorporated herein by reference.

### BACKGROUND OF THE INVENTION

1. Field of the Invention

The invention relates generally to actuators for relatively moving two elements, and specifically related to improvements in actuator technology to provide actuators that provide both a motive force with damping via the use of hydraulic and pneumatic aspects.

2. Discussion of Prior Art

Components for providing moving force, in assisting moving force, and/or a holding force are known. Such components are often referred to as actuators, lifters, gas springs or the like, such components are often used to move one part relative to another. In one specific example, such components are utilized for movement of a part of a vehicle. In one specific example, the part of a vehicle is a door. Often, such components are utilized where the moving part (e.g., a door), is of significant weight, bulk, or the like, or the part is moved to a position that is subject to an external influence, such as gravity which urges a reverse movement of the part. In one specific example, an upwardly pivoting door of an aircraft tends to be merged toward a closed position under the influence of gravity.

Often associated with two moving and often associated with a movement actuator are components which damp (e.g., slow or limit) movement caused by one or more actuators. Such components are often called dampers. A typical damper construction includes the use of a fluid (e.g., hydraulic or pneumatic) which is permitted to flow, within a pathway, but in a restricted or metered manner.

Often, dampers and actuators are utilized together to provide for/control a single movement (e.g., one part moving relative to another part). Each of the actuator and damper providing its respective function. However, some circumstances/environments may be hindered by the utilization by separate actuators and dampers. For example, within an aircraft environment, space and weight are often considerations. Separate actuators and dampers logically consume a greater volume of space and weight.

### BRIEF DESCRIPTION OF THE INVENTION

The following summary presents a simplified summary in order to provide a basic understanding of some aspects of the systems and/or methods discussed herein. This summary is not an extensive overview of the systems and/or methods discussed herein. It is not intended to identify key/critical elements or to delineate the scope of such systems and/or methods. Its sole purpose is to present some concepts in a simplified form as a prelude to the more detailed description that is presented later.

In accordance with one aspect, the present invention provides an actuator for relatively moving two parts in a damped manner. The actuator includes a damper housing for connection to a first of the parts. The damper housing includes a damper chamber. The actuator includes a drivable damper rod for connection to a second of the parts and being movable relative to the damper housing. The damper rod includes a damper unit located within the damper chamber. The damper unit is relatively movable within the damper chamber with the damper unit movement corresponding to the relative movement between the damper housing and damper rod and the relative movement between the first and second parts. The damper unit is movable in response to hydraulic pressure force upon the damper unit. The actuator includes a pneumatic pressure source for providing a pneumatic pressure force that is transferred to provide the hydraulic pressure force upon the damper unit. The actuator includes a selectively actuatable blocking device for permitting transfer of the pneumatic pressure force from the pneumatic pressure source and blocking return of force to the pneumatic pressure source until the selectively actuatable blocking device is actuated.

### BRIEF DESCRIPTION OF THE DRAWINGS

The foregoing and other aspects of the invention will become apparent to those skilled in the art to which the invention relates upon reading the following description with reference to the accompanying drawings, in which:

FIG. 1 is a schematic illustration of an example hydro-pneumatic actuator in accordance with an aspect of the present invention within an example environment with two relatively moveable parts;

FIG. 2 is a schematic illustration of a known multi-component arrangement for an environment with two relatively moveable parts similar that of FIG. 1, with such multi-component arrangement being replaceable by the example actuator of FIG. 1;

FIG. 3 is a perspective view of the example actuator of FIG. 1;

FIG. 4 is a section view of the example actuator of FIG. 3 taken along line 4-4 in FIG. 3;

FIG. 5 is an enlarged view of the encircled portion designated 5 within FIG. 4 and is a portion of the actuator of FIG. 4 that includes a blocking valve; and

FIG. 6 is section view taken along line 6-6 in FIG. 5 and shows the portion that includes the blocking valve.

### DETAILED DESCRIPTION OF THE INVENTION

Example embodiments that incorporate one or more aspects of the invention are described and illustrated in the drawings. These illustrated examples are not intended to be a limitation on the invention. For example, one or more aspects of the invention can be utilized in other embodiments and even other types of devices. Moreover, certain terminology is used herein for convenience only and is not to be taken as a limitation on the invention. Still further, in the drawings, the same reference numerals are employed for designating the same elements.

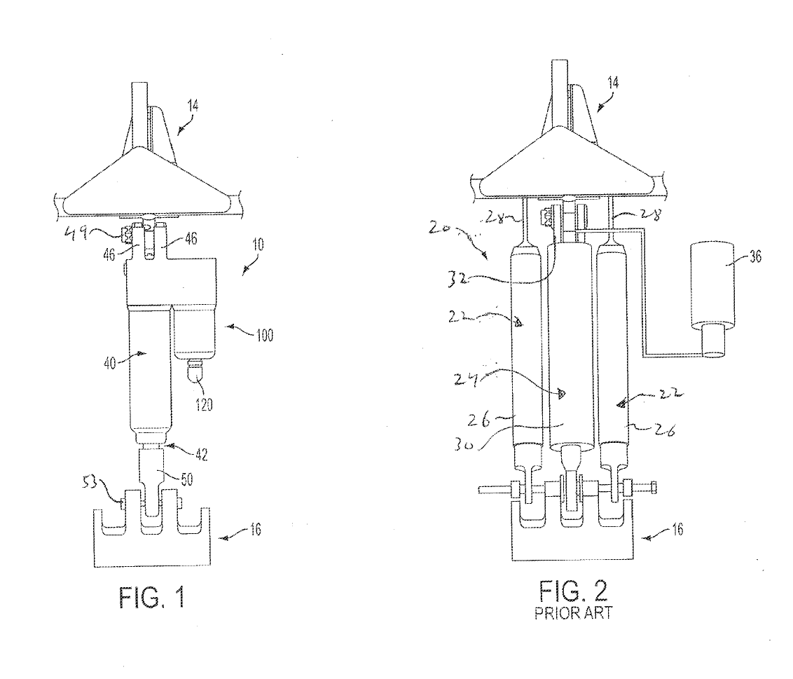

An actuator 10 in accordance with at least aspect of the present invention is shown in FIG. 1, in connection with two relatively movable parts 14, 16. It is to be appreciated that the two parts 14, 16 are only partially shown and are only schematically shown. The two parts 14, 16 may be any relatively moveable parts. Within one example, the parts 14, 16 are of a vehicle. Within one specific example, the parts 14, 16 are of an aircraft vehicle. Further, the first part 14 is a door (only partially shown) which permits entry and egress concerning the interior of the aircraft. The second part 16 may be a chassis or the frame (only partially shown) of the aircraft. Also, the first part 14 may be an overhead lifted door which is thus subject to the influence of gravity urging the door closed once the door is moved to an open condition.

Move

The actuator may have any suitable construction to permit connection to the first and second parts. For example, bearings, such spherical bearings, in connection with connection bolts may be utilized at each of the first and second ends of the actuator.

It is to be appreciated that in accordance with at least one aspect of the present invention, the actuator 10 provides both an actuating force to relatively move the two parts 14, 16 (e.g., urge the first part, which can be a door, to move relative to the second part, which can be an aircraft chassis) and a damping force to moderate or control the relative movement of the two parts. It is to be appreciated that such combination of two functions within a single actuator 10 can replace the plural functions of plural devices of prior arrangement 20. For example, FIG. 2 shows an example of such a prior arrangement 20. The prior arrangement is shown in connection with the same example parts 14, 16.

Within the shown example arrangement of FIG. 2, two gas lifting springs 22 and a separate damper 24 are provided. Each of the gas lifting springs 22 includes a surrounding cylinder portion 26 with an internal chamber (not visible). The cylinder portion 26 is connected to the second part 16. A piston portion 28 having a piston head (not visible) and an extension rod is movable relative to the cylinder 26 and connected to the first part 14. The piston head is located within the internal chamber of the cylinder portion 26 and is movable relative thereto. A pressurized gaseous gas is located within the cylinder 26 and is entrapped within the internal chamber by the piston head of the piston portion 28. As such, each gas spring 22 provides an urging force to move the first part 14 relative to the second part 16. In general, the gas springs 22 simply provide the urging force. Moreover, there is no tempering or metering of the urging force provided by the gas springs 22. As such, the associated damper 24 provides a damping force in concert with the urging forces provided by the gas springs 22. The damper 24 includes a cylinder portion 30 connected to the second part 16 and a relatively moveable damper portion 32 connected to the first part 14. The cylinder portion 30 includes an internal chamber (not visible). The damper portion 32 includes a damper head (not visible), which is located within the internal chamber of the cylinder portion 30 and movable relative thereto. The damper head includes one or more metering or restriction orifices. A hydraulic fluid is provided within the internal chamber, with a reserve supply of the hydraulic fluid being provided by an associated reservoir 36. During relative movement of the damper head within the internal chamber, the hydraulic fluid is allowed to pass the damper head in a restricted or metered manner. Such fluid movement provides a resistive or damping force. Such damping force in compliment to the urging forces provided by the gas springs 22 provides an overall force for movement of the first part 14 (e.g., a door) relative to the second part 16 (e.g., an aircraft chassis) in a managed/desired manner. It is to be appreciated, however, that multiple components (e.g., 22 and 24) providing multiple separate functions are present within the arrangement shown in FIG. 2.

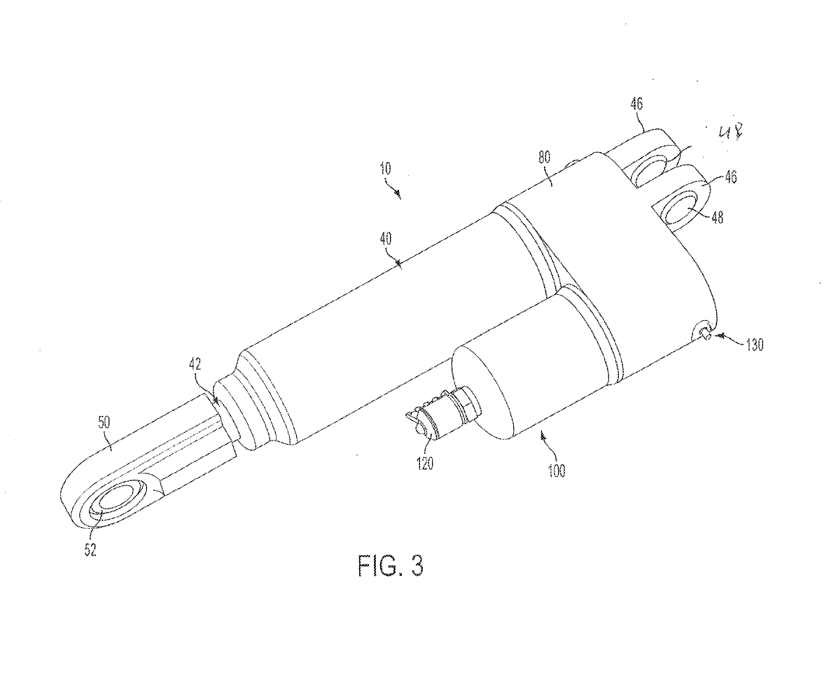

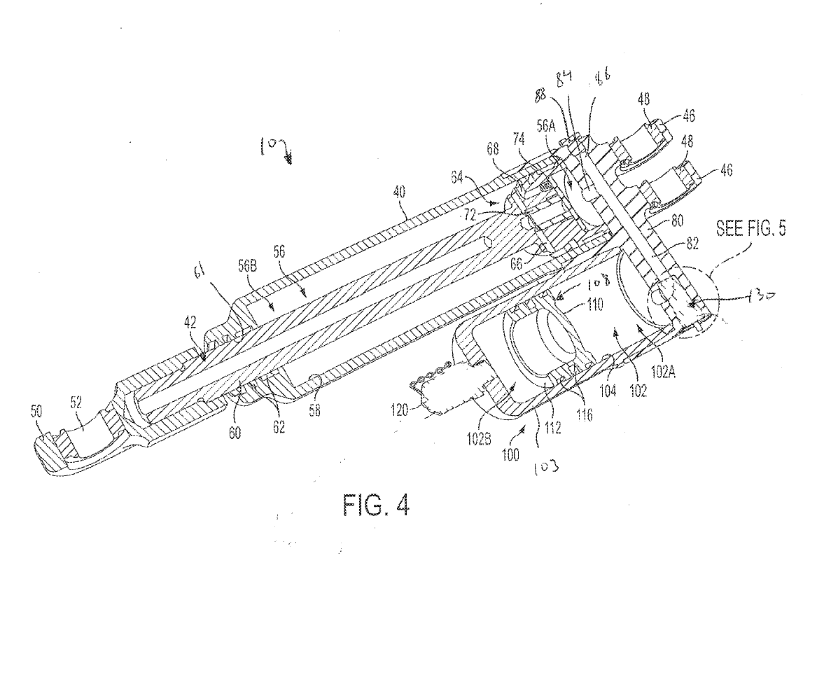

Turning back to the example actuator 10 in accordance with at least one aspect of the present invention, the actuator is shown in greater detail in FIGS. 3 and 4. The actuator 10 includes a damper housing 40 for connection to one of the first and second parts 14, 16. Within the shown example, the damper housing 40 is connected to the first part 14 (e.g., the door). However, it is to be appreciated that the actuator 10 can be connected in a reverse manner (e.g., the damper housing 40 being connected to the second part 16). Within the shown example, the damper housing 40 has a mounting clevis 46 with one or more spherical bearings 48 to receive a connection bolt or pin 49 (FIG. 1) to connect the damper housing to the first part 14. As shown in FIG. 4, the damper housing includes a hollow interior that provides a damper chamber. Within the shown example the damper chamber is a cylindrical elongate chamber.

The actuator includes a drivable damper rod 42 for connection to the second part 16 (FIG. 1) which is movable relative to the damper housing 40. Within the shown example, the damper rod includes a rod end or clevis 50 that has a spherical bearing 52, which can receive a bolt or pin 53 to connect the rod end to the second part 16. As previously mentioned, the actuator 10 could be reversed such that the rod end clevis 50 would be connected to the first part 14.

Turning back to FIG. 4, the damper housing has an internal damper chamber 56 defined by an internal surface 58. In the shown example, the internal surface 58 is an elongate cylindrical shape and the damper chamber 56 has a spherical cross-section due to the elongate cylindrical shape. The internal chamber has two axial ends. The damper rod 42 includes an elongate portion 60 that extends through an aperture 61 of the damper housing 40 and into the damper chamber 56. One or more seals, wipers, and the like (location generically identified by reference number 62) may be present at the aperture 61 and thus at an interface of the damper housing 40 and the elongate portion 60 of the damper rod 42. The seals, wipers and the like engage the elongate portion 60 and provide for retention of a hydraulic fluid, which is discussed further below.

Located at a distal end of the damper rod 42 and located within the damper chamber 56 is a damper unit 64. Within the shown example, the damper unit 64 is akin to a piston portion of the damper rod 42. Further, within the shown example, the damper unit 64 is constructed as an enlarged head on the elongate portion 60 of the damper rod 42. Within the shown example, the elongate portion 60 and the damper rod 42 are constructed as a single, monolithic member. It is to be appreciated that variations in construction of the damper rod 42 and specifically the damper unit 64 are possible. For example, the damper unit 64 may be separately constructed and subsequently connected to the elongate portion 60.

Turning to focus upon the damper unit 64, it is to be appreciated that an outer-most periphery of the damper unit 64 engages in a mating arrangement with the interior surface 58 of the damper chamber 56. Accordingly, the outer-most periphery of the damper unit 64 has a spherical cross-section. One or more seals and/or wipers may be located upon the damper unit to prohibit hydraulic fluid bypassing the exterior periphery of the damper unit 64 along the interior surface 58 of the damper housing 40. It is to be appreciated that, similar to the locations 62 for seals, etc. engaging the elongate portion 60, locations for seals, wipers, and the like, are provided on the periphery of the damper unit 64. Numbering is not provided to avoid drawing cutter.

The damper unit 64 divides the damper chamber 56 into first and second chamber portions 56A, 56B. It is to be appreciated that the relative sizes of the two chamber portions 56A, 56B can dynamically vary or change as the damper unit 64 moves within the damper housing 40. Movement of the damper unit 64 relative to the damper housing 40 is associated with the movement of the entire damper rod 42 relative to the damper housing 40. Moreover, since the first and second parts 14, 16 (see FIG. 1) are connected to the damper housing 40 and damper rod 42, respectively, the movement of the damper unit 64 corresponds to relative movement of the first and second parts. It is to be appreciated that hydraulic fluid is present within the damper chamber 56. Pressure influence from the hydraulic fluid upon the damper unit 64 can cause movement of the damper unit 64. Again, movement of the damper unit 64 within the damper chamber 56 of the damper housing 40 corresponds to relative movement of the two parts 14, 16 (FIG. 1).

The damper unit 64 (FIG. 4) is configured and constructed such that only certain hydraulic fluid pressures cause movement of the damper unit 64. The damper unit 64 is also configured and constructed such that external forces applied to the actuator 10 do not result in hydraulic fluid pressure forces that might otherwise induce movement or hinder movement of the damper unit 64. Specifically, the damper unit 64 includes at least one conduit (e.g., 66, 68) that extends through the damper unit for connection of the two damper chamber portions 56A, 56B through the damper unit. Within the shown example, at least two conduits 66, 68 through the damper unit 64 are provided. Each conduit (e.g., 66, 68) can provide a selective fluid connection between the two chamber portions 56A, 56B through the damper unit 64. It is to be appreciated that each conduit (e.g., 66, 68) may be a single conduit or contain multiple conduct paths, Also, it is to be appreciated that each conduit (e.g., 66, 68) may have a single branch or multiple branches.

The first conduit 66 has a restrictor component 72 located therein. The other conduit 68 includes a flow check valve 74 located therein. It is to be appreciated that specific structures for the restrictor component 72 and the flow check valve 74 need not be specific limitations upon the present invention and as such, various constructions/configurations are possible and contemplated. It is to be appreciated that each of the restrictor component 72 and the flow check valve 74 may be a single structure or multiple structures. Such single or multiple structures may be associated with single or multiple conduits/branches.

During movement of the damper unit 64 within the damper chamber 56 to extend the damper rod 42 out from the damper housing 40, hydraulic fluid pressure is exerted on a first end (e.g., face) of the damper unit which faces the chamber portion 56A. Such hydraulic pressure caused the movement that forces/extends the damper rod 42 out from the damper housing 40. However, such hydraulic pressure also forces hydraulic fluid through the restrictor component 72 at a controlled rate of flow. At an end of such an extending stroke, the damper unit 64 can come to rest against a distal end of the damper housing 40.

During a retraction movement (i.e., the damper rod 42 is moved back into the damper housing 40 and thereby reducing the overall length of the actuator 10), the damper unit 64 moved away from the distal end within the chamber 56. In other words, the movement of the damper unit 64 is toward the end opposite through which rod 42 extends. It is to be appreciated that such movement is typically caused via an externally applied force to the actuator 10. In one example, the force may be a force applied to the first part 14 (FIG. 1). In the specific example of the first part 14 being an aircraft door, the force may be a closing force applied to the door to close the door against the chassis of the aircraft. It is to be appreciated that such externally applied moving force may tend to cause force imposition upon the hydraulic fluid within the damper chamber 56. However, the check valve 74 within the damper unit allows free flow of fluid as the damper unit 64 moves during the retraction. As such, no damping (e.g., resistance to movement) is provided due to the free flow permitted by the check valve 74.

Turning back to the damper housing 40, a portion of the damper housing is provided as a manifold 80 that includes at least one conduit 82. The conduit 82 has a port 84 that connects into the damper chamber 56 at the first chamber portion 56A. The conduit 82 does extend to an external orifice 86 which is designed as a fill port. Hydraulic fluid can be introduced into the actuator 10 and, thus, introduced into the first chamber portion 56A of the damper chamber 56, via the fill port 86. The fill port 86 is fitted with a threaded, removable plug 88 which secures the provided hydraulic fluid within the actuator 10. The details of the plug and the conduit portion thereat need not be specific limitations upon the present invention and various constructions/configurations are contemplated.

In accordance with at least one aspect of the present invention, the manifold 80 and the conduit 82 therein extends to a pneumatic pressure source (e.g., a gas spring arrangement) 100 that provides a pneumatic pressure force that is transferable to provide a hydraulic pressure force within the damper chamber 56. Specifically, the conduit 82 extends to connect to an internal chamber 102 of a housing 103. The internal chamber 102 is defined by an internal surface 104 of the housing 103. The chamber 102 can have an elongate cylinder shape.

A floating piston 108 is movably located within the chamber 102. The piston has two ends of faces 110, 112 and divides the chamber 102 into two chamber portions 102A and 102B. The floating piston 108 may include one or more seals, wipers or the like. The location of the seals, etc. are generally shown by reference number 116. The floating piston, in combination with its seals, etc., sealingly separates the two chamber portions 102A, 102B.

The conduit 82 extending from the damper chamber 56 extends toward the first chamber portion 102A within the gas spring arrangement 100. As such, hydraulic fluid may be present within the first chamber portion 102A. The second chamber portion 102B of the gas spring arrangement 100 contains a compressed gaseous gas. In one specific example, the gaseous gas is an inert gas. Of course, use of other gases is possible. The gas is introduced into the second chamber portion 102B of the gas spring housing arrangement 100 via a fill valve 120 located at a distal end of the housing 103. The pneumatic pressure of the entrapped gas may be varied, however, it is intended that the pressure be selected such that the pneumatic pressure provided by the entrapped gas urges the floating piston 108 away from the fill valve end of the gas spring housing 103. Movement of the floating piston 108, such as in response to the urging pneumatic pressure force, increases the size of the second chamber portion 102B of the gas spring housing chamber 102, and thereby reduces the size of the first chamber portion 102A. Moreover, such urging tends to urge hydraulic fluid located in the first chamber portion 102A of the gas spring housing 103 to move along the conduit 82 within the manifold 80 and thus into the first chamber portion 56A within the damper housing 40.

As can be appreciated, entry of hydraulic fluid into the first chamber portion 56A of the damper housing 40 causes an increase in pressure within the first chamber portion 56A and an urges the damper unit 64 to move within the damper chamber 56 and thus extend the damper rod 42 out from the damper housing 40. Accordingly, as previously discussed, such hydraulic pressure and urging force provided therefrom move the damper rod 42 and relatively moves the first and second parts 14, 16 (e.g., movement of the door open away from the aircraft chassis).

It is to be appreciated that the movement of the floating piston 108 within the gas spring arrangement 100 is dynamic. During a desired movement of the two parts 14, 16 (e.g., movement of the aircraft door to move relative to the aircraft chassis), the pneumatic force provided by the gas spring arrangement is permitted to be transferred to provide the hydraulic pressure within the damper housing 40 and move (e.g., extend) the damper rod 42 outward relative to the damper housing 40. Typically such movement is not externally resisted (e.g., a person dues not stop movement of the opening door). As such, the force provided by the gas spring arrangement 100 causes the movement (e.g., the opening of the door). Of course, as previously discussed, the damping function provided by the restrictor component 72 within the associated conduit 66 of the damper unit 64 provide a controlled or damped movement.

When it is desired to reverse the movement of the two parts 14, 16 (e.g., close the door against the aircraft chassis) an external force (e.g., a person pushing upon the aircraft door in a closing motion), will cause the damper rod 42 to move back into the damper housing 40 in a retracting movement. Fluid within the fiat portion of the damper chamber 56A is forced to move into the conduit 82 extending within the manifold 80 and back into the first chamber portion 102A within the gas spring housing arrangement 100. Such movement of hydraulic fluid is associated with a transfer of force into the first chamber portion 102A of the gas spring housing 103. Such force causes movement of the floating piston 108. Such movement, in turn, causes compression of the entrapped gas within the second chamber portion 102B of the gas spring housing 103. The pneumatic pressure is thus increased. It is to be appreciated that such increase in force provides a retained potential energy force that can be utilized during a subsequent permitted actuation movement (e.g., opening of the door).

As such, the actuator 10 provides a self-contained arrangement that provides a dual function of providing relative motive force (e.g., a door opening force) in combination with the function of providing damped movement. Still further due to the presence of the check valve 74, there is little or no resistive damping force against a reverse relative movement (e.g., door closing motion).

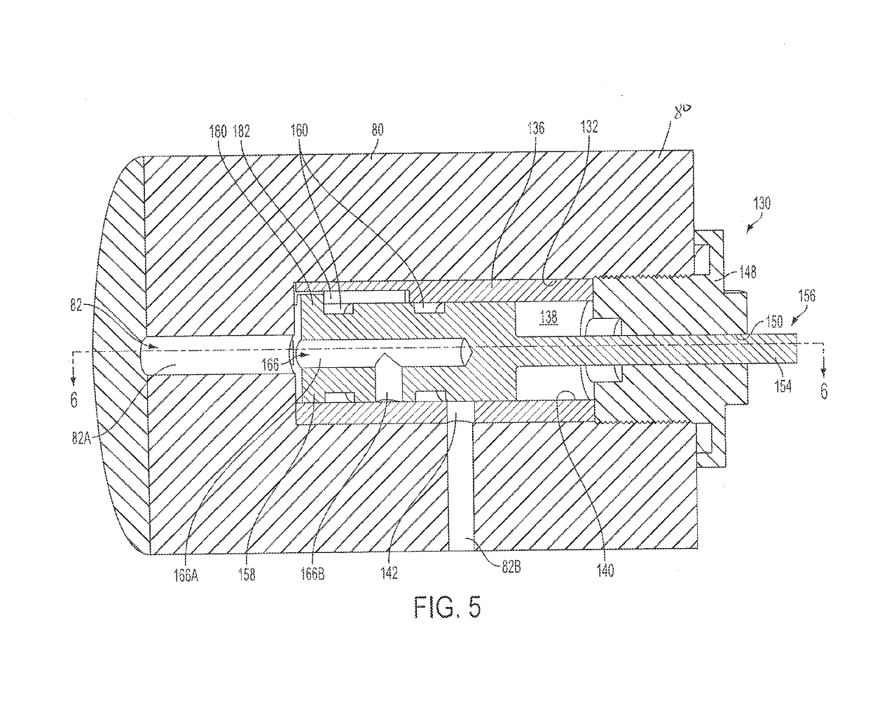

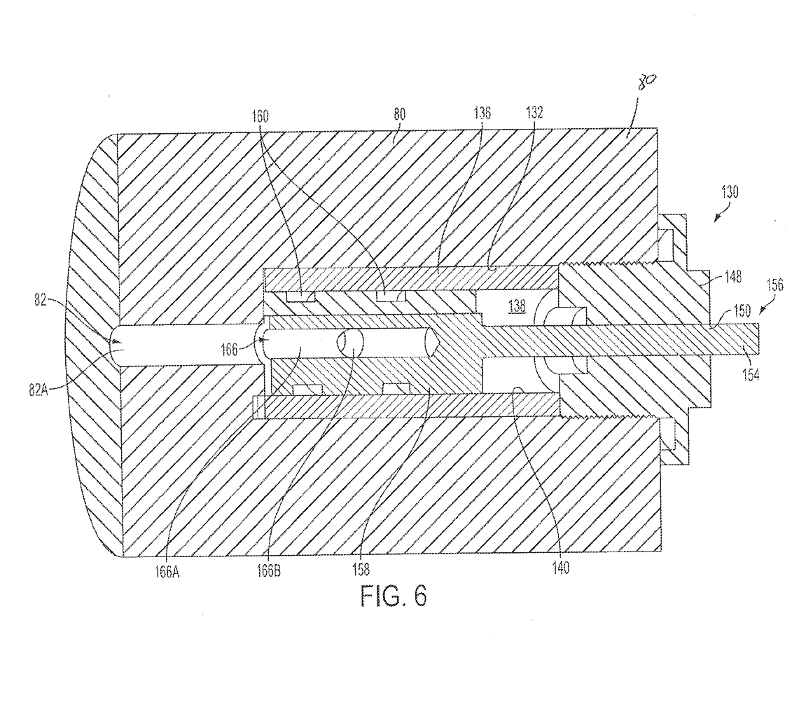

It is to be appreciated that it may be desirable to prevent or block the influence of the gas spring arrangement 100 from acting upon the hydraulic fluid within the damper housing 40. Also, it may be desirable to prevent the return of hydraulic fluid to the gas spring arrangement 100 and thus help to retain the damper rod 42 in an extended condition (e.g., retain the door in an open position relative to the aircraft chassis). Accordingly, one aspect of the present invention provides for a blocking device 130 within the conduit 82 of the manifold 80. The blocking device 130 blocks movement of hydraulic fluid within the conduit 82 between the first chamber portion 56A of the damper housing 40 and the first chamber portion 102A of the gas spring housing 103. It is to be appreciated that the blocking device 130 may have various constructions and configurations. FIGS. 5 and 6 show one example of a blocking device 130 as a blocking valve 130.

Within FIG. 5, a portion of the manifold 80 that includes the conduit 82 shows that the conduit 82 has a first segment 82A of the conduit that extends transverse between the damper housing 40 and the gas spring housing 103 and a second segment 82B of the conduit that extends to the gas spring housing. A portion of the conduit aligned with the transverse conduit segment is bored 132 to increase the diameter and to allow insertion of valve components. Within the in-bored enlargement 132, a valve sleeve 136 is inserted. The valve sleeve 136 has a cylindrical outer surface that generally mates to the diameter of the in-bored enlargement 132. The valve sleeve 138 has a hollow interior 138 defined by an interior surface 140. The interior surface 140 of the valve sleeve 136 is also generally cylindrical shape. The hollow interior 138 of the valve sleeve 136 is open to the transverse conduit segment 82A such that fluid within the transverse conduit segment can be selectively permitted to proceed into and through the valve sleeve.

A borehole 142 extends through the valve sleeve 136 transverse to the extent of the valve sleeve and in open mating position to the conduit segment 82B that proceeds to the gas spring housing 103. As such, hydraulic fluid can pass from the interior 138 of the valve sleeve 136 to or from the conduit segment 82A leading to the gas spring housing 103. A valve cap 148 is threaded into the bored enlargement 132 of the manifold 80 to block the end of the enlarged hole and also to retain the valve sleeve 136 within the bored enlargement. The cap 148 does have a plunger bore 150 that extends through the cap. The plunger bore 150 receives a valve plunger 154 of a valve member 156 which is located within the interior 138 of the valve sleeve 136 and which is entrapped within the valve sleeve by the cap 148.

The valve member 156 includes a valve body 158 within the valve sleeve 136 which moves relative to the valve sleeve 136 as the entire valve member 156 is moved. Such movement is imparted by movement or force imposed upon the valve plunger 154 extending through the cap 148. In one example, the movement may be a manual movement imparted by an operator (e.g., a person manually actuating the valve).

Turning back to the valve body 158, the valve body has a general outward profile that is complimentary to the cylindrical inner surface 140 of the valve sleeve 136. The length of the valve body 158 is less than the overall length of the valve sleeve 136. Accordingly, there is room to permit shifting (lateral, left-right, shifting as shown in the FIGS. 5 and 6). The valve body 158 has one or more annular grooves 160 that receives valve seals, wipers, or the like to seal fluid at appropriate locations. The valve body 158 has a conduit 166 extending through the valve body which can permit the flow of hydraulic fluid through the valve body when the valve body is at an appropriate position. Within the shown example, the conduit 166 through the valve body includes two segments 166A, 166B. A first segment 166A is aligned with the transverse segment 82A in the manifold 80 and a second segment 166B is perpendicular to the first segment 166A.

The second segment 166B of the conduit 166 through the valve body 158 can be moved into alignment with the through borehole 142 through the valve sleeve 136 and the passage segment 82B extending to the gas spring housing 103. During such alignment, fluid may flow through the valve body 158. However, the valve body 158 can also be moved to a position (as shown in FIG. 5), in which the second conduit segment 166B in the valve body is not aligned. As such, fluid cannot flow though the valve body 158. Accordingly, the blocking valve 130 can be actuated to stop the flow of fluid.

In order to maintain proper rotational orientation (i.e., prevent rotation) of the valve body 158 relative to the valve sleeve 136, the valve body 158 has a tab or key 180 and the sleeve 136 has a keyway 182. During sliding of the valve body 158 relative to the sleeve 136, the tab can freely slide along the keyway 182. However, the sleeve 136, at the keyway 182, prevents rotational movement.

As previously discussed, fluid flow blockage can be utilized to prevent the pneumatic force provided by the gas spring housing arrangement 100 from transferring a hydraulic force to the damper housing 40. Such can be considered to be a disconnect function to disconnect the gas spring housing 103 from the damper housing 40. Such may be useful when it is desired not to have the damper unit be under the influence of hydraulic pressure caused by the transfer of pressure force from the gas spring housing arrangement. Also, it may be desirable to block the gas spring housing arrangement 100 from the damper housing 40 when the rod 42 is in a fully extended position. Such may be the case for the example of an aircraft door being open and there being a desire to help retain the door in the open condition. Blocking provided by the blocking device (i.e., the blocking valve) 130 would prevent flow of hydraulic fluid from the first chamber of the damper chamber to the first chamber of the gas spring housing arrangement.

Thus, in accordance with an aspect of the present invention, the single hydro-pneumatic actuator 10 includes one hydraulic working fluid and one pneumatic working gas. It is to be appreciated that various hydraulic fluids and various pneumatic gases may be utilized. Various considerations can be made to select a hydraulic fluid and a pneumatic gas. Considerations may be based upon operating environments, densities, viscosities, temperature tolerance, flow considerations, seal/wiper/bearing compatibility, various hazards, and other factors.

It is to be appreciated that the volume of hydraulic and pneumatic gas can be varied dependent upon various considerations. Certainly, the overall chamber sizes and chamber portion sizes are a first consideration. Still further, the desire to stroke length of the damper rod, the weight of the connected parts that are moved, and other structural considerations can be factored used to determine volumes. Still further, if it is to be appreciated that the surface profiles of the damper unit and/or the floating piston can be designed to provide for different force reception profiles by the fluid and/or gas pressing thereupon. In short summary, geometric variables to increase, decrease size, or in the case of the damper unit flow of fluid there through, can be modified to provide desired force/movement profiles.

The invention has been described with reference to the example embodiments described above. Modifications and alterations will occur to others upon a reading and understanding of this specification. Example embodiments incorporating one or more aspects of the invention are intended to include all such modifications and alterations insofar as they come within the scope of the appended claims.

What is claimed is:

1. An actuator for relatively moving two parts in a damped manner, the actuator including:
a damper housing for connection to a first of the parts, the damper housing including a damper chamber;
a drivable damper rod for connection to a second of the parts and being movable relative to the damper housing, the damper rod including a damper unit located within the damper chamber, the damper unit being relatively movable within the damper chamber with the damper unit movement corresponding to the relative movement between the damper housing and damper rod and the relative movement between the first and second parts, the damper unit being movable in response to hydraulic pressure force upon the damper unit;
a pneumatic pressure source for providing a pneumatic pressure force that is transferred to provide the hydraulic pressure force upon the damper unit; and
a selectively actuatable blocking device for permitting transfer of the pneumatic pressure force from the pneumatic pressure source and blocking return of force to the pneumatic pressure source until the selectively actuatable blocking device is actuated.

2. An actuator as set forth in claim 1, wherein the pressurized pneumatic pressure source includes a gaseous gas storage container that bounds a volume to retain an amount of pressurized gaseous gas and that is coupled to the damper housing.

3. An actuator as set forth in claim 2, wherein the storage container includes an internal chamber and a movable piston within the internal chamber, the piston divides the internal chamber into first and second portions, and the piston retains the gas within the first portion and moves under the pneumatic pressure force to transmit the pneumatic pressure force.

4. An actuator as set forth in claim 3, wherein the coupling of the storage container to the damper housing includes a conduit, the selectively actuatable blocking device is located along the conduit.

5. An actuator as set forth in claim 4, wherein liquid fluid can flow between the second compartment of the storage container and the damper housing through the conduit.

6. An actuator as set forth in claim 1, wherein the damper unit includes at least one passage to permit fluid to flow past the damper unit within the damper housing.

7. An actuator as set forth in claim 1, wherein the pneumatic pressure source includes a chamber divided into two chamber portions by a piston, a first of the chamber portions being for hydraulic fluid and a second of the chamber portions being for pneumatic gas.

8. An actuator as set forth in claim 7, wherein pressure upon the piston of the pneumatic pressure source can move hydraulic fluid from the second chamber portion.

9. An actuator as set forth in claim 1, wherein the damper unit permits some flow of hydraulic fluid past the damper unit.

10. An actuator as set forth in claim 9, wherein the damper unit includes a flow restrictor.

11. An actuator as set forth in claim 9, wherein the damper unit includes a fcheck valve.

12. An actuator as set forth in claim 1, wherein the selectively actuatable blocking device is manually actuatable.
